(19) United States
(12) Patent Application Publication
(10) Pub. No.: US 2018/0046768 A1
(43) Pub. Date: Feb. 15, 2018

(54) SYSTEM FOR TRACKING PATIENT WAIT TIMES AT A HEALTHCARE CLINIC

(71) Applicant: Sync Times, LLC, Wenatchee, WA (US)

(72) Inventor: Marcus Paskett, Wenatchee, WA (US)

(21) Appl. No.: 15/232,523

(22) Filed: Aug. 9, 2016

(51) Int. Cl. G06F 19/00

(52) U.S. Cl. CPC G06F 19/327; G06F 19/322

(57) ABSTRACT

A system including a patient services computing device, readers, a wait time system, encounter area (“EA”) display devices, and a waiting area display device. The computing device assigns a token to each of the patients. The readers each correspond to one of a plurality of areas and read information from the tokens. The wait time system receives the information from the readers, identifies, as being used, the area corresponding to each reader, and calculates wait times for those patients whose tokens have not yet been read. The EA display devices each correspond to one of the areas. Each of the EA display devices receives an indication from the wait time system and displays whether the corresponding area is being used based on the indication. The waiting area display device displays the wait time calculated for those patients whose tokens have not yet been read.

### BACKGROUND

### Field of the Invention

The present invention is directed generally to systems for tracking waiting times at healthcare clinics.

### Description of the Related Art

Modern delivery of healthcare has become a technology driven field. For example, a healthcare facility may have one or more complex computer systems that control the facility. Such systems track patients, patient records, tests, and the like. Further, computer systems are used to help manage and monitor medical staff. Unfortunately, technology has not been used effectively to determine patient wait times or to use that information to plan staffing. Therefore, a need exists for systems and methods of tracking wait times and demand at a healthcare clinic. The present application provides these and other advantages as will be apparent from the following detailed description and accompanying figures.

### BRIEF DESCRIPTION OF THE SEVERAL VIEWS OF THE DRAWINGS

FIG. 1 is a block diagram of a plurality of healthcare organizations connected to a wait time system.

FIG. 2 is a block diagram illustrating a healthcare clinic of one of the healthcare organizations of FIG. 1.

FIG. 3 is a block diagram of the wait time system connected to a plurality of computing and display devices of the healthcare clinic of FIG. 2.

FIG. 4 is a block diagram illustrating a patient receiving care at the healthcare clinic of FIG. 2.

FIG. 5 is a flow diagram of a method performed by the wait time system of FIG. 1.

FIG. 6 is an illustration of a screen showing patient wait times displayed by a display device provided in a waiting area of the healthcare clinic of FIG. 2.

FIG. 7 is an illustration of a screen showing medical staff member status displayed by the display device provided in the waiting area of the healthcare clinic of FIG. 2.

FIG. 8 is an illustration of a screen displayed by an external display device of the healthcare clinic of FIG. 2.

FIG. 9 is an illustration of a screen displayed by a display device of a flow area computing device of the healthcare clinic of FIG. 2.

FIG. 10 is an illustration of an encounter area management screen of an administrative portal displayed by a display device of a patient services computing device of the healthcare clinic of FIG. 2.

FIG. 11 is an illustration of a patient visit management screen of the administrative portal displayed by the display device of the patient services computing device of the healthcare clinic of FIG. 2.

FIG. 12 is an illustration of a first screen displayed by a display device of an encounter area computing device of the healthcare clinic of FIG. 2.

FIG. 13 is an illustration of a second screen displayed by the display device of the encounter area computing device of the healthcare clinic of FIG. 2.

FIG. 14 is an illustration of a third screen displayed by the display device of the encounter area computing device of the healthcare clinic of FIG. 2.

FIG. 15 is a diagram of a hardware environment and an operating environment in which the computing devices of FIGS. 1-4 may be implemented.

Like reference numerals have been used in the figures to identify like components.

### DETAILED DESCRIPTION

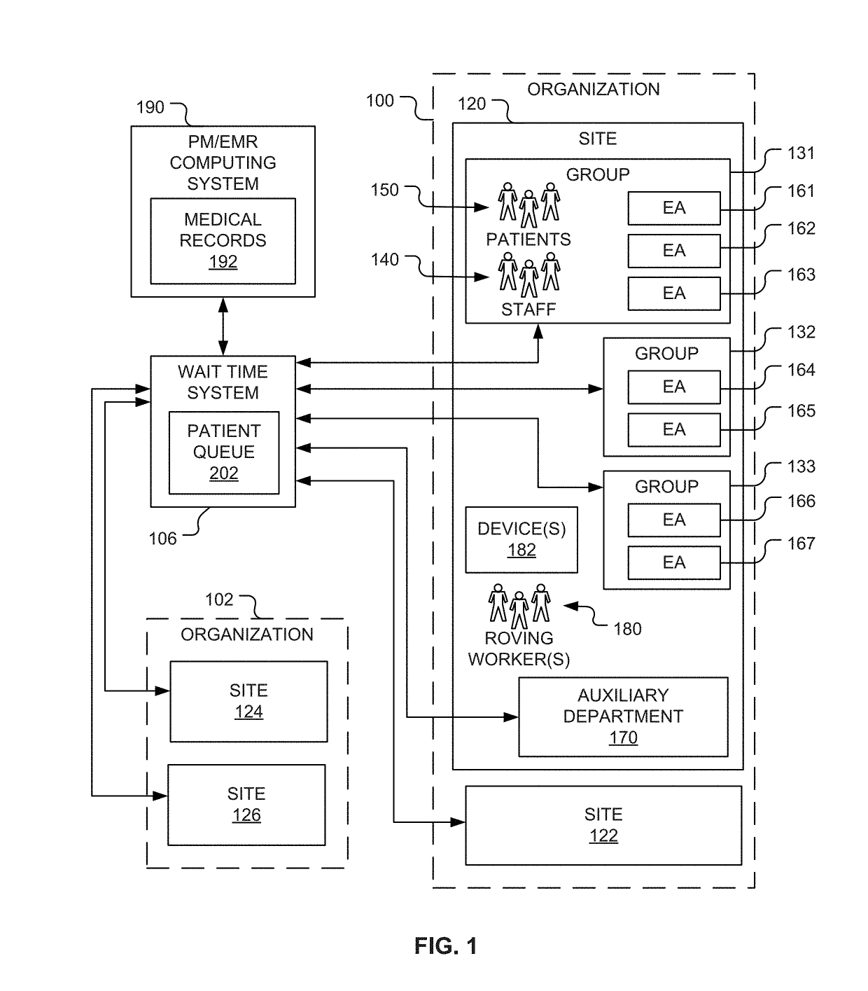

FIG. 1 is a block diagram of a plurality of healthcare organizations 100 and 102 connected to a wait time system 106. Each of the organizations 100 and 102 has one or more physical locations (referred to as sites). For ease of illustration, the organization 100 has been illustrated as including sites 120 and 122, and the organization 102 has been illustrated as including sites 124 and 126.

Within each site, each of the organizations 100 and 102 may include one or more groups. For ease of illustration, the site 120 has been illustrated as including three groups 131-133. However, each of the sites 120-126, may include any number of groups. Some of the patients 150 may “walk-in” to one of the groups 131-133 (e.g., the group 131) and others of the patients 150 may have appointments. By way of non-limiting examples, a group may be a separate practice or department. For example, the group 131 may be an urgent care clinic, a walk-in clinic, an express care facility, and the like. For ease of illustration, the group 131 will be described as being a healthcare clinic 131.

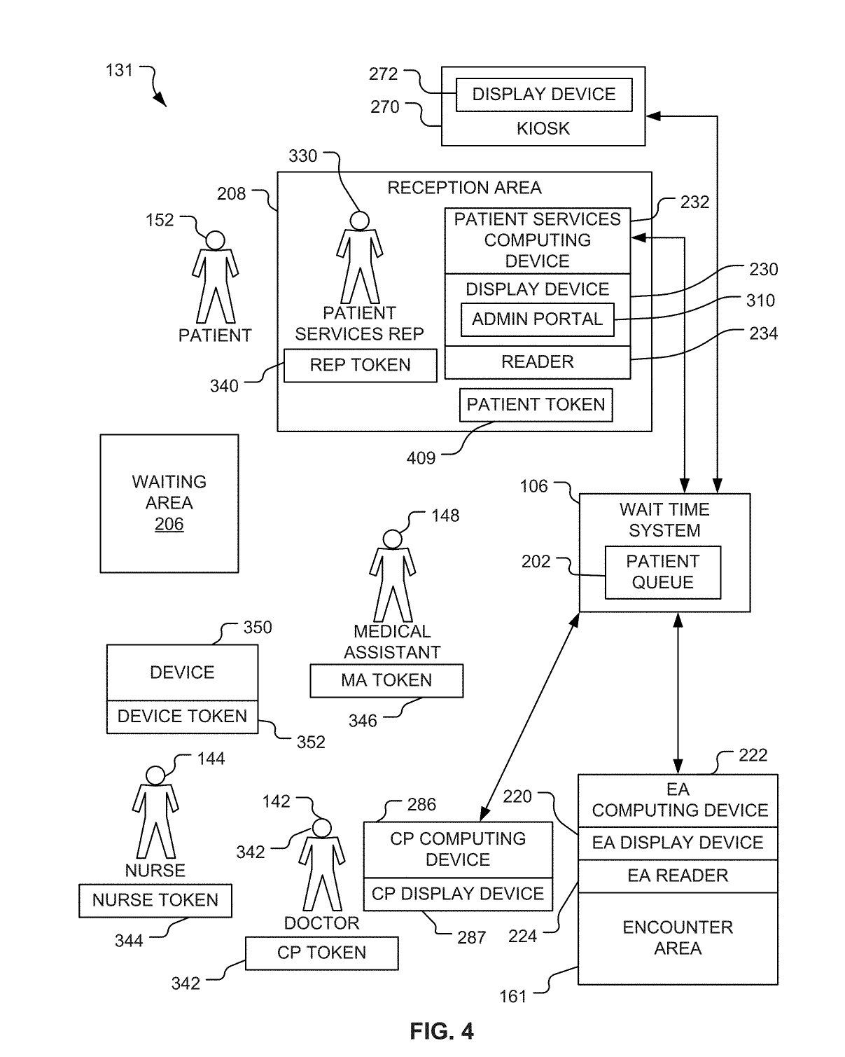

Each of the groups 131-133 includes medical staff 140 that provide healthcare services to patients 150 (e.g., a patient 152 depicted in FIG. 4). Referring to FIGS. 4 and 7, non-limiting examples of members of the medical staff 140 include physicians or doctors 142 and 146, a nurse 144, a medical assistant 148, a nurse practitioner, a pharmacist, a behavioral health specialist, and the like.

Each of the groups 131-133 has one or more encounter areas where the patients 150 are examined and/or treated by at least one member of the medical staff 140. For ease of illustration, the group 131 has been illustrated as including three encounter areas 161-163, the group 132 has been illustrated as including two encounter areas 164 and 165, and the group 133 has been illustrated as including two encounter areas 166 and 167. However, each of the groups 131-133, may include any number of encounter areas. As will be explained in more detail below, each group (e.g., the groups 131-133) within an organization (e.g., the organization 100) is connected to the wait time system 106.

The wait time system 106 assigns at least some of the members of the medical staff 140 to one of the groups. Each of the encounter areas may also be assigned to a group. Optionally, at least some of the members of the medical staff 140 may be assigned to an encounter area. A staff member may temporary change the membership (e.g., the medical staff and/or the encounter areas) assigned to a group.

Optionally, each site may include one or more auxiliary departments (e.g., an auxiliary department 170) that is responsible for providing services (upon request) to the groups (e.g., the groups 131-133) within the site (e.g., the site 120). When present, each auxiliary department is connected to the wait time system 106. In the example illustrated, the site 120 includes the auxiliary department 170, which provides services to the groups 131-133 and is connected to the wait time system 106. By way of non-limiting examples, the auxiliary department 170 may be laboratory or radiology department.

Optionally, each site (e.g., the site 120) may have one or more roving workers 180 (e.g., auxiliary staff members). Each of the roving workers 180 is an employee responsible for clinical or ancillary care in more than one group (e.g., the groups 131-133). Non-limiting examples of the roving workers 180 include a phlebotomist who draws blood in multiple groups, a janitorial worker who cleans the encounter areas of multiple groups throughout a site. The site 120 may include any number of roving workers.

One or more of the sites (e.g., the site 120) may include one or more devices 182 (e.g., a device 350 illustrated in FIG. 4) that may be used (as appropriate) to provide healthcare services to one or more of the patients 150. One or more of the devices 182 may be mobile (e.g., movable to one of the encounter areas 161-167) or fixed (e.g., installed in the auxiliary department 170). By way of non-limiting examples, the device(s) 182 may include medical imaging devices, and the like.

The wait time system 106 may be connected to a practice management and/or an electronic medical record (“PM/EMR”) computing system 190 that stores patient medical records 192. Each of the patient medical records 192 stores a medical record number (“MRN”) that uniquely identifies one of the patients 150 who is associated with the record.

The wait time system 106 may have a system administrator (not shown). Further, each of the organizations 100 and 102 may have an organizational system administrator (not shown). Additionally, each of the sites 120-126 may have a site system administrator (not shown). Each of the groups 131-133 may have a group system administrator (not shown).

The wait time system 106 is configured to provide the patients 150 with real-time information regarding wait times within one of the groups 131-133. Wait time refers to an amount of time that one of the patients 150 is estimated to wait before being checked into one of the encounter areas (e.g., one of the encounter areas 161-163) of one of the groups (e.g., the group 131). In other words, the wait time system 106 provides an estimate of an amount of time that one of the patients 150 will have to wait before being served. The wait time system 106 maintains and updates a patient queue 202. The patient queue 202 indicates an order in which the patients 150 will be served and is used to calculate wait times. The wait time system 106 may also improve workflow with respect to the medical staff 140 to improve efficiency. Further, the wait time system 106 may improve workflow with respect to the patients 150 to better serve them.

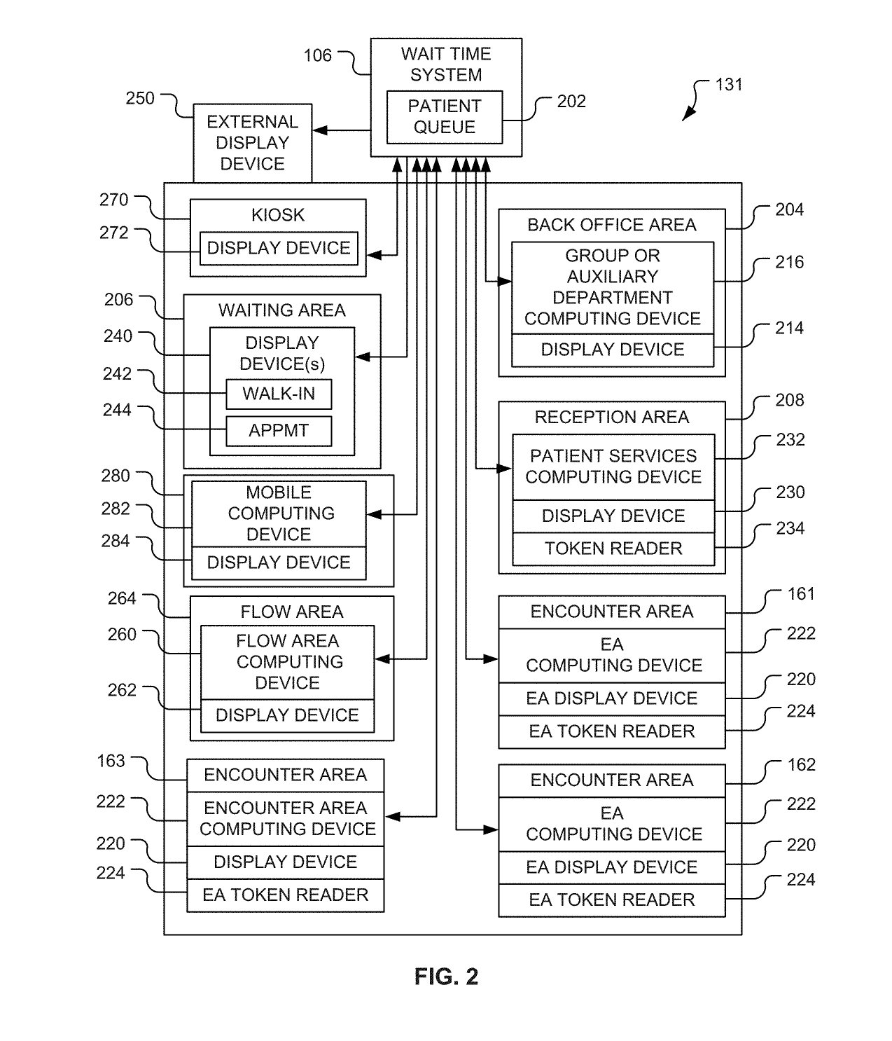

FIG. 2 is a block diagram of the healthcare clinic 131 connected to the wait time system 106. Each of the groups 132 and 133 may be configured similarly to the healthcare clinic 131. As mentioned above, the clinic 131 includes the encounter areas 161-163. The clinic 131 may also include an optional back office area 204, a waiting area 206, and a reception area 208.

By way of non-limiting examples, the back office area 204 may include a group or auxiliary department display device 214 coupled to a computing device 216. The display device 214 provides overall situational information (e.g., in a graphical format) to the medical staff 140 (see FIG. 1) and/or staff of the auxiliary department 170 (see FIG. 1). By way of a non-limiting example, the display device 214 may be implemented as a display portion of a tablet (e.g., an iPad) computing device. The display device 214 and the computing device 216 may be used to change a group message (e.g., selected from a predefined list of messages). By way of another non-limiting example, the display device 214 and the computing device 216 together may be implemented as a tablet computing device (e.g., an iPad, and the like).

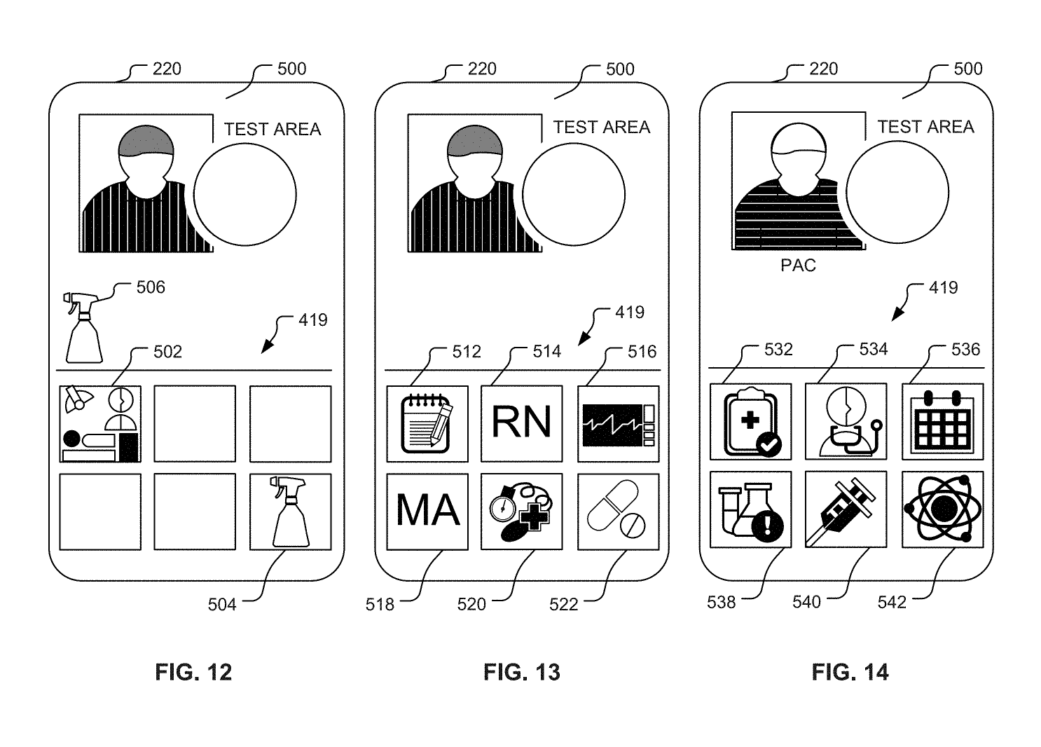

Each of the encounter areas 161-163 includes an EA display device 220 coupled to an EA computing device 222. Within each of the encounter areas 161-163, the EA computing device 222 and the EA display device 220 may be implemented using a small, programmable, interactive display device (e.g., a tablet computing device such as an iPad). The EA computing device 222 and the EA display device 220 may be mounted next to a door of one of the encounter areas 161-163. Optionally, each of the encounter areas 161-163 may include a second EA computing device and a second EA display device (like the EA computing device 222 and the EA display device 220, respectively) positioned (e.g., mounted) inside of the encounter area. Each of the encounter areas 161-163 includes a token reader 224. The token reader 224 may be implemented using a camera of the EA computing device 222 or the EA display device 220. Alternatively, the token reader 224 may be a separate device connected to the wait time system 106 via the EA computing device 222 or a separate connection. As will be described below, FIGS. 12-14 depict a screen 500 that is displayable by the EA computing device 222 and the EA display device 220.

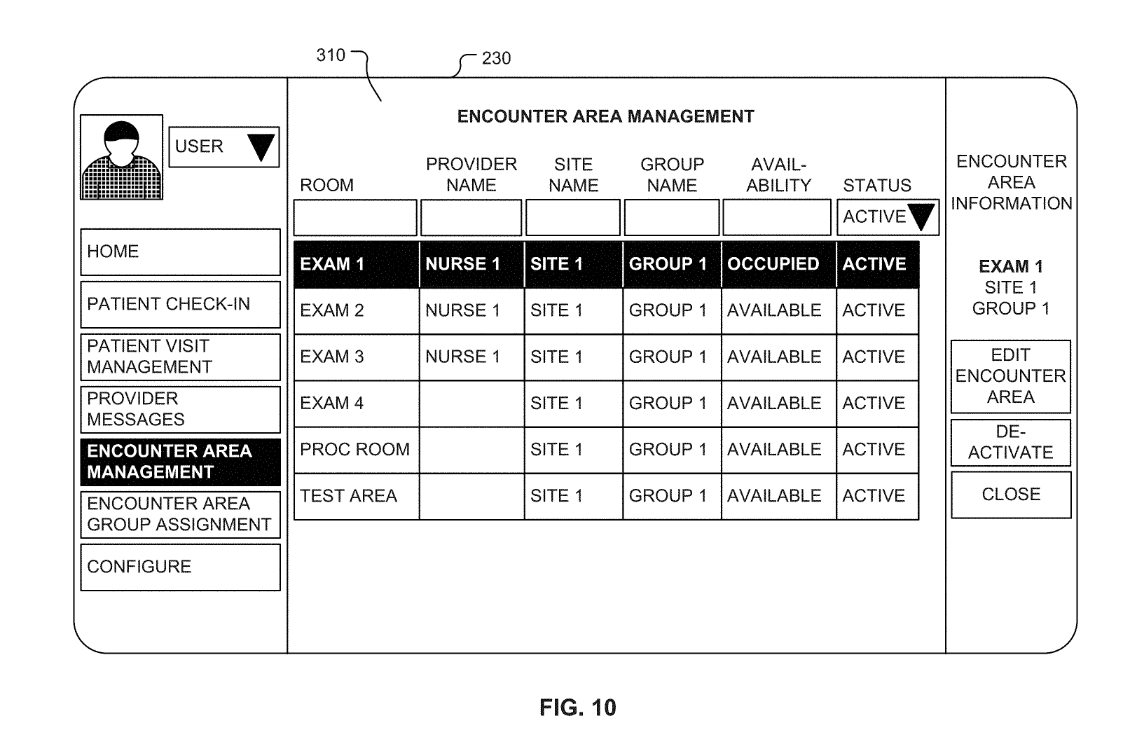

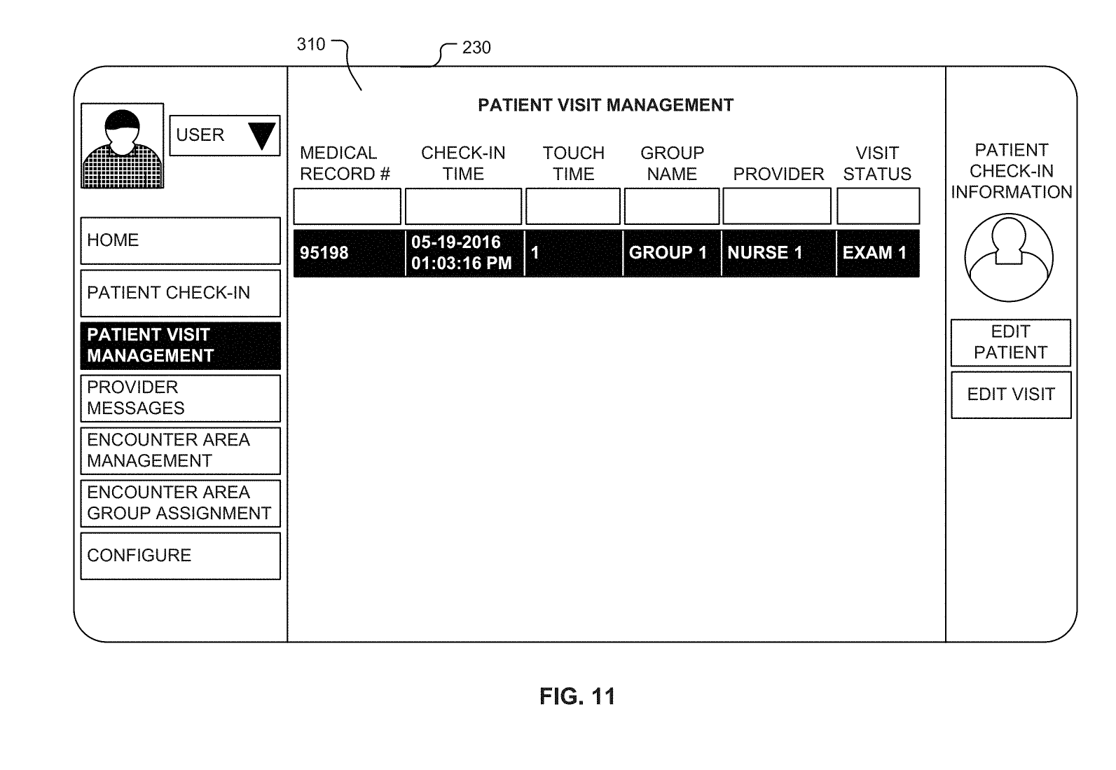

Referring to FIG. 2, the reception area 208 may include a display device 230 connected to a patient services computing device 232. The display device 230 and the patient services computing device 232 may be implemented as a medium-sized mounted interactive display device. For example, the display device 230 and the patient services computing device 232 may be implemented using a tablet computing device (e.g., an iPad). Alternatively, the display device 230 may be implemented as an additional computer monitor separate from a monitor (not shown) connected to the PM/EMR computing system 190 (see FIG. 1). As will be described below, FIGS. 10 and 11 depict an administration or admin portal 310 that is displayable by the display device 230 and the patient services computing device 232.

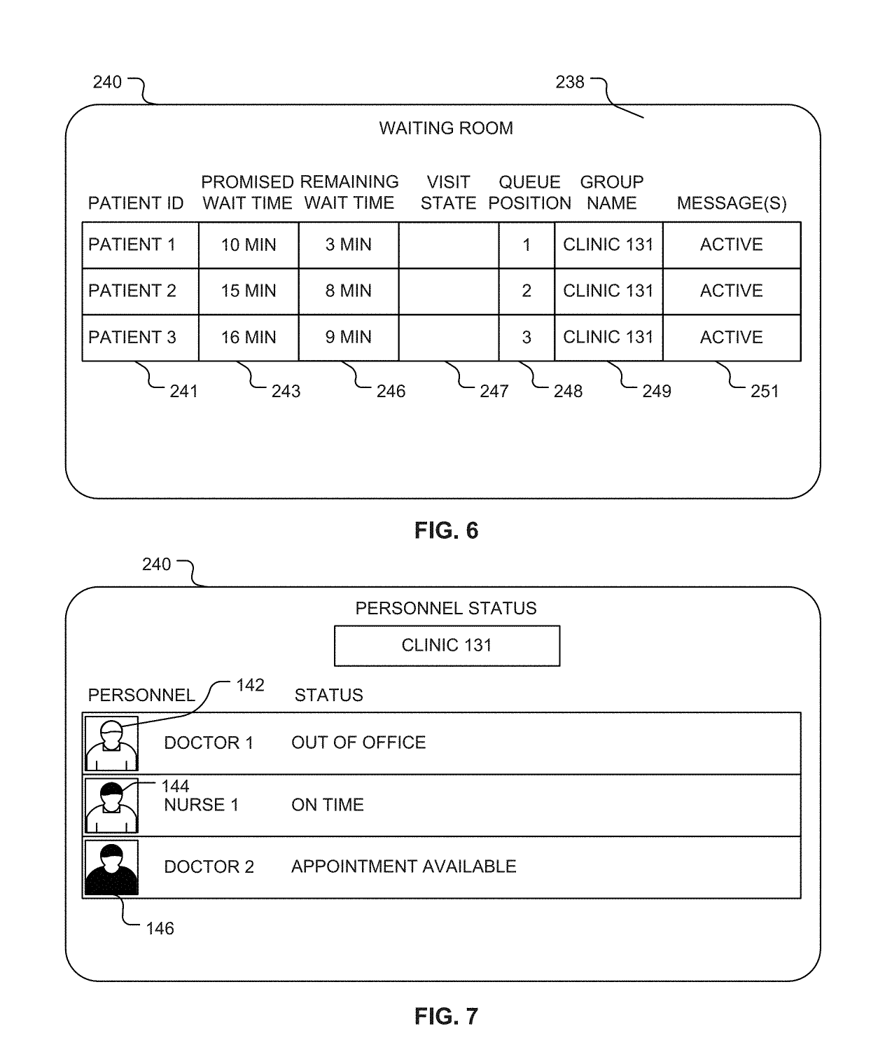

Referring to FIG. 2, the waiting area 206 may include one or more display devices 240. The display device(s) 240 may each be implemented as a large non-interactive monitor that displays information to the patients 150 (see FIG. 1) regarding their current status and wait time. The display devices 240 may include an express care or walk-in display 242 and an appointment display 244. The walk-in display 242 may display wait time information with respect to each walk-in patient in the patient queue 202 and the appointment display 244 may display wait time information with respect to each patient in the patient queue 202 who scheduled an appointment. If the appointment display 244 is shared by more than one group, one group's information may be displayed at a time. Referring to FIG. 6, the displays 242 and 244 (see FIG. 2) may each display a screen 238 for each group that includes, for each patient waiting for services by the group, a unique patient identifier 241, a promised wait time (“PWT”) 243, a remaining wait time 246, a visit state value 247, a queue position 248, a name of the group 249, and one or more messages 251 (e.g., a group status message, a message from a member of the medical staff 140, and the like).

Referring to FIG. 2, the message(s) 251 (see FIG. 6) displayed by the screen 238 (see FIG. 6) may include a message for the group (e.g., the group 131) and/or a message to the patients of a particular member of the medical staff 140 (see FIG. 1). On the other hand, the message(s) 251 (see FIG. 6) displayed by the walk-in display 242 may include a message for the group (e.g., the group 131). A care team of each of the groups 131-133 (a medical assistant, a nurse, another care provider, and the like) may change the published group message.

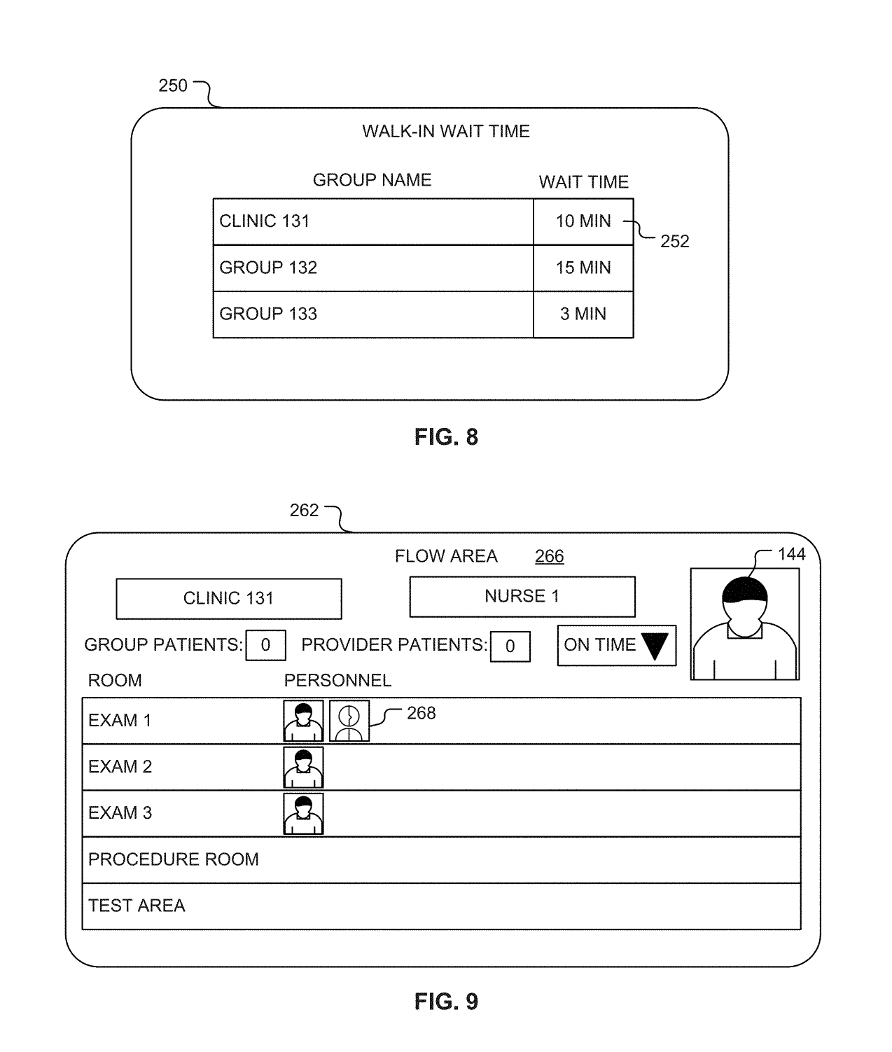

The wait time system 106 may also be connected to an external display device 250 visible to passersby outside the clinic 131. By way of non-limiting examples, the external display device 250 may be implemented as a “Watchfire” sign, an outdoor LCD display, and the like. Referring to FIG. 8, the external display device 250 is used to display an advertised wait time (AWT) 252 to passersby outside the clinic 131 (see FIGS. 1, 2, and 4). The AWT 252 is a projected amount of time that a prospective walk-in patient may wait before the prospective patient is taken to an encounter area for an examination and/or treatment. A separate AWT 252 is calculated for each group (e.g., the groups 131-133).

The AWT 252 is calculated for each of the groups 131-133 (see FIG. 1) based on (1) the number of patients in the patient queue 202 of the group, (2) the number of encounter areas available to the group and (3) the number of members of the medical staff 140 available to the group. By way of a non-limiting example, the AWT 252 may be calculated for a particular group based on the following parameters:

Average Turn Time (“ATT”), which is an estimated turn over time for each encounter area for the current time of day and day of the week;

Minimum Wait Time (“MWT”), which is an estimated minimum wait time for the current time of day and day of the week;

Available Encounter Areas (“AEA”), which is a total number of encounter areas that are available (or open) in the group;

Patients Waiting (“PatW”), which is a total number of patients currently waiting (e.g., in the waiting area 206); and

Patients in Exam (“PatE”), which is a total number of patients currently in the encounter areas of the group.

For example, if the PatW/AEA is less than AEA, there are more encounter areas than there are patients waiting for an encounter area. In this case, the AWT 252 may be determined to be the MWT. On the other hand, if PatW/AEA is equal to AEA, there are an equal number of encounter areas and patients waiting for an encounter area. In this case, the AWT 252 may be determined to be a sum of ATT and MWT. Finally, if the PatW/AEA is greater than AEA, there are fewer encounter areas than there are patients waiting for an encounter area. In this case, the AWT 252 may be determined using the following formula:

(PatW/AEA*ATT)+(SumRET/AER)+MWT.

In the above formula, SumRET is a summation of a RET value calculated for each patient. RET is equal to (((ATT/60)−(Current_Time−Checkin_Time))*60) when the patient has been checked in but has not yet checked out. Otherwise, Ret is equal to zero. Current_Time is the current time and Checkin_Time is the time the wait time system 106 recorded for checking the patient in to the encounter area 161.

The AWT 252 may be recalculated every time there is a change in the number of patients in the patient queue 202, the number of available encounter areas, and/or the number of available members of the medical staff 140. The AWT 252 may also be recalculated occasionally (e.g., at one minute intervals).

The wait time system 106 is connected to a flow area computing device 260 coupled to a display device 262. The flow area computing device 260 is located in a flow area 264 accessible by the medical staff 140 (see FIG. 1). In particular, the flow area computing device 260 may be accessed by the nurse 144 and/or the medical assistant 148. The display device 262 shows information related to the encounter areas 161-163 of the clinic 131, the doctors, 142 and 146, the nurse 144, and the medical assistant 148. At least one of the doctors 142 and 146, the nurse 144, and/or the medical assistant 148 may be assigned (or appointed) to one of the encounter areas 161-163. The display device 262 allows an appointed member of the medical staff 140 (see FIG. 1) to select a message to display on the displays 242 and 244 (see FIG. 2) in the waiting area 206. For non-appointed members of the medical staff 140 (see FIG. 1), the display device 262 may display the current wait time.

Referring to FIG. 8, the flow area computing device 260 may display a screen 266 configured for one of the groups 131-133 and one of the members of the medical staff 140 (see FIG. 1). In FIG. 8, the screen 266 has been illustrated displaying information for the clinic 131 and the nurse 144. In the embodiment illustrated, the screen 266 displays indicia “EXAM 1,” “EXAM 2,” and “EXAM 3” corresponding to the encounter areas 161-163 (see FIG. 1), respectively, and shows a picture of the nurse 144 next to the indicia “EXAM 1,” “EXAM 2,” and “EXAM 3,” which indicates that the nurse 144 is currently appointed to the encounter areas 161-163 (see FIG. 1). The screen 266 also shows a picture 268 of another member of the medical staff 140 (see FIG. 1) next to the indicia “EXAM 1” indicating that member is appointed to the encounter area 161.

In some embodiments, the wait time system 106 is also connected to an optional kiosk 270. The kiosk 270 includes or is connected to a display device 272. The kiosk 270 may be implemented by a medium-sized, touch-screen, interactive display device. For example, the kiosk 270 may be implemented using a tablet computing device (e.g., an iPad).

Optionally, the wait time system 106 may be connected to one or more mobile devices 280. One or more of the medical staff 140 (see FIG. 1) and/or the roving workers 180 (see FIG. 1) may be assigned to a different mobile device 280. In the embodiment illustrated, the mobile device 280 has been implemented as a mobile computing device 282 connected to a mobile display device 284. By way of a non-limiting example, referring to FIG. 4, the mobile device 280 may be implemented as a CP computing device 286 connected to a CP display device 287. By way of another non-limiting example, the mobile device 280 may be implemented as a roving computing device (not shown) connected to a roving display device (not shown). The mobile device 280 may be implemented using a tablet computing device (e.g., an iPod Touch, an iPad, and the like).

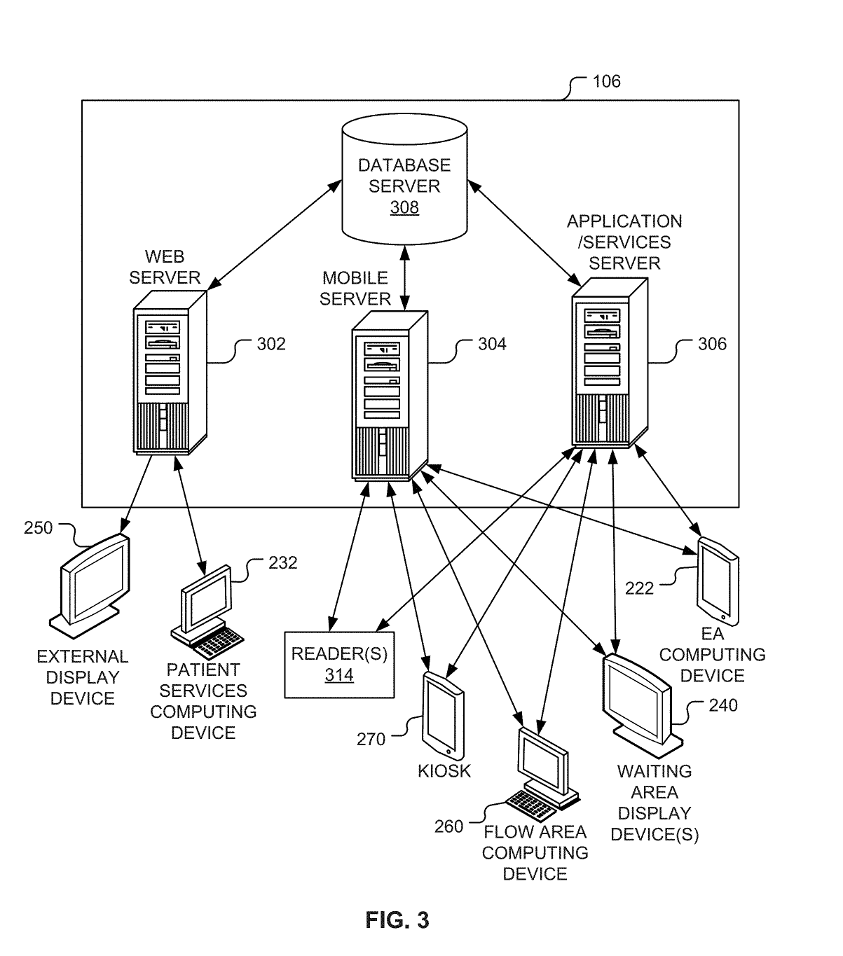

FIG. 3 is a block diagram of the wait time system 106. In the embodiment illustrated, the wait time system 106 includes a web server 302, a mobile server 304, an application/services server 306, and a database server 308. The database server 308 stores data and communicates with the web mobile server 304, the mobile server 304, and the application/services server 306.

The web server 302 updates the AWT 252 (see FIG. 8) displayed by the external display device 250. The web server 302 also communicates with the admin portal 310 (see FIGS. 10 and 11) displayed by the display device 230 (see FIG. 2) of the patient services computing device 232. For example, the web server 302 receives data from the admin portal 310 and sends that data to the database server 308. Conversely, the web server 302 receives data from the database server 308 and sends that data to the admin portal 310. FIG. 10 depicts an embodiment of an encounter area management screen and FIG. 11 depicts an embodiment of a patient visit management screen.

The servers 304 and 306 each communicate with one or more token reader 314 (e.g., the readers 224 and 234 illustrated in FIG. 2), the flow area computing device 260, and the AE computing device 222. Optionally, the servers 304 and 306 may communicate with the mobile device(s) 280 (e.g., see FIG. 2), the group or auxiliary department computing device 216, and the kiosk 270, when present.

Referring to FIG. 4, as mentioned above, the clinic 131 is operated the medical staff 140 (see FIG. 1). In the example illustrated, the medical staff 140 includes a patient services representative 330, the nurse 144, the doctors 142 and 146, and the medical assistant 148. Optionally, the medical staff 140 (see FIG. 1) may also include the roving worker(s) 180 (see FIG. 1), one or more auxiliary staff members, and the like.

Each of the medical staff 140 (see FIG. 1) operating the clinic 131 signs into the wait time system 106 using a login and a password. Further, each of these people may be assigned a unique token that is associated with the person and that uniquely identifies that person. The token is machine-readable by the readers 314. As used herein, the term “token” refers to a physical object, such as a printed 3D barcode (e.g., on a badge), a radio-frequency identification (“RFID”) tag, a smart card (e.g., HID® encoded card), a proximity card, and the like. In the example illustrated in FIG. 4, the patient services representative 330, the doctor 142, the nurse 144, and the medical assistant 148 are assigned tokens 340-346, respectively. Additionally, each of the device(s) 182 (see FIG. 1) may be assigned a unique token that is associated with the device and that uniquely identifies that device. For example, in FIG. 4, a device 350 is assigned a token 352.

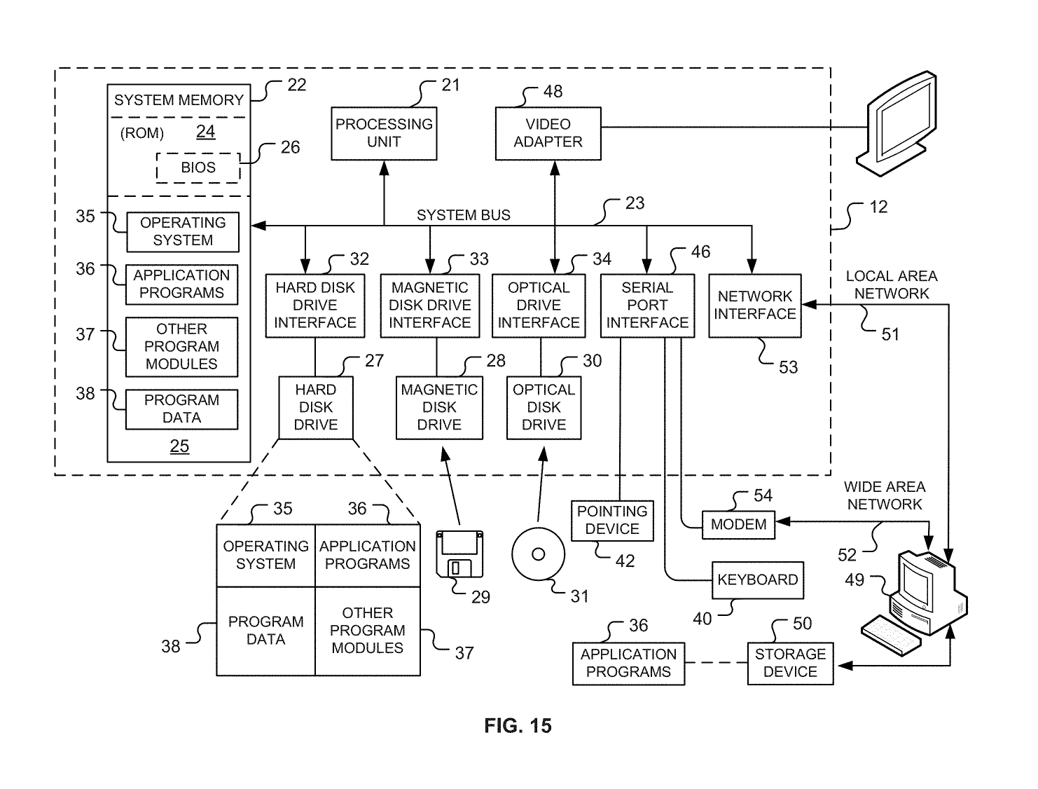

As illustrated in FIGS. 1-4, the wait time system 106 is connected to the PM/EMR computing system 190, each of the computing devices 216, 222, 232, 260, 270, and 282, and the display devices 240 and 250. Each of the computing systems and devices 190, 216, 222, 232, 260, 270, and 282 may be implemented as a computing device 12 (see FIG. 15) described below. Additionally, each of the servers 302-308 may be implemented using the computing device 12 (see FIG. 15).

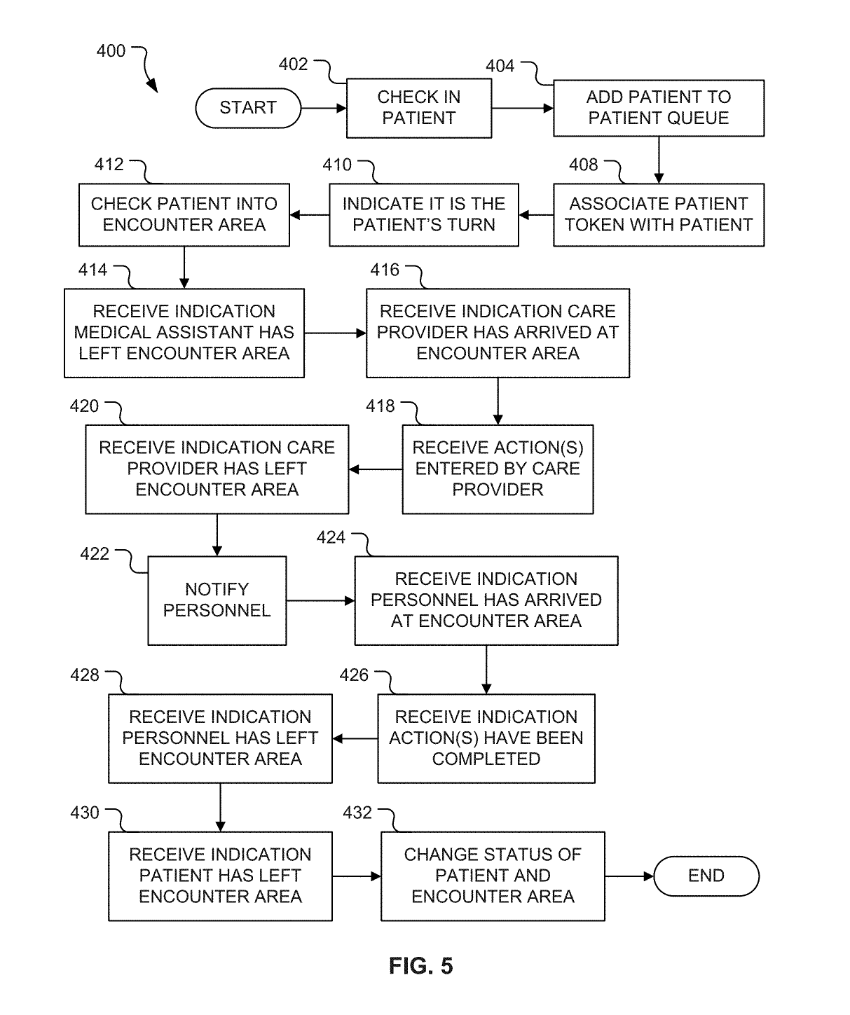

FIG. 5 is flow diagram of a method 400 performed by the wait time system 106. Before the method 400 begins, referring to FIG. 4, the patient 152 enters the clinic 131 and decides whether to check in using the optional kiosk 270 or the patient services representative 330. Returning to FIG. 5, in first block 402, the wait time system 106 (see FIGS. 1-4) checks in the patient 152 (see FIG. 4). By way of non-limiting examples, checking in the patient 152 may involve verifying the patient's identity, confirming identity and contact information, and obtaining a valid and correct medical record number (“MRN”) from the PM/EMR computing system 190 (see FIG. 1). Further, additional steps may be necessary to register the patient 152 for the appointment in the PM/EMR computing system 190. In block 402, referring to FIG. 4, the wait time system 106 receives check in information from either the optional kiosk 270 or the patient services representative 330 (via the admin portal 310). If the patient 152 used the optional kiosk 270, the patient 152 enters information into the optional kiosk 270 in response to questions displayed on the display device 272. The entered information is transmitted by the kiosk 270 to the wait time system 106. The kiosk 270 may display the AWT 252 (see FIG. 8) to the patient 152. On the other hand, if the patient 152 went directly to the patient services representative 330, the patient services representative 330 enters information into the admin portal 310, which is transmitted thereby to the wait time system 106.

After the patient 152 has been checked in, referring to FIG. 5, a patient visit is initiated. In block 404, the wait time system 106 adds the patient 152 to the patient queue 202 (see FIGS. 1, 2, and 4). In block 404, the wait time system 106 assigns a Patient Arrival Time (“PAT”) to the patient 152. The wait time system 106 may also validate queue information and calculate both the PWT 243 (see FIG. 6) and the AWT 252 (see FIG. 8). The PWT 243 is specific to the patient 152. Optionally, the wait time system 106 may provide the PWT 243 to the patient 152 (e.g., via the patient services representative 330 or the kiosk 270 illustrated in FIG. 4). In block 404, referring to FIG. 2, the wait time system 106 may also update the display device(s) 240 in the waiting area 206, the CP display device 287 (see FIG. 4), and/or the external display device 250. Referring to FIG. 4, after the patient 152 is added to the patient queue 202, the patient 152 may go to the waiting area 206. The patient 152 may monitor the walk-in display 242 or the appointment display 244, whichever is appropriate, to view current wait times.

In block 408, referring to FIG. 4, the wait time system 106 associates a patient token 409 with the patient 152. For example, the wait time system 106 may prompt the patient services representative 330 to scan (via the reader 234) the patient token 409 and associate the patient token 409 with the patient 152 during the visit. The patient services representative 330 may keep the patient token 409 (e.g., behind a reception desk in the reception area 208) or give the patient token 409 to the patient 152.

The patient 152 waits until it is the patient's turn. Then, referring to FIGS. 4 and 5, in block 410, the wait time system 106 indicates (e.g., to the medical assistant 148) that the patient 152 is next in the patient queue 202. This indication may be displayed on one of the mobile devices 280 operated by the medical assistant 148. The medical assistant 148 escorts the patient 152 from the waiting area 206 into one of the encounter areas 161-163 (see FIG. 1. For ease of illustration, the patient 152 will be described as having been escorted to the encounter area 161. The medical assistant 148 may collect the patient token 409 (e.g., from behind the reception desk). Alternatively, the medical assistant 148 may obtain the patient token 409 from the patient 152.

In block 412, the wait time system 106 checks the patient 152 (and optionally, the medical assistant 148) into the encounter area 161. Checking the patient 152 into the encounter area 161 also removes the patient 152 from the waiting list displayed on the walk-in display 242 or the appointment display 244, whichever is appropriate, in the waiting area 206.

In block 412, the wait time system 106 receives an indication that both the medical assistant 148 and the patient 152 have arrived at the encounter area 161. For example, the medical assistant 148 may use the EA reader 224 to read token information from both the MA token 346 and the patient token 409. The EA reader 224 provides the token information to the wait time system 106. The EA display device 220 displays options from which the medical assistant 148 may select. Non-limiting examples of such options include assigning the patient 152 to the encounter area 161, checking a current patient out (presented if there is another patient currently checked into the encounter area 161), canceling the current action, and accepting the current action. The medical assistant 148 may enter or exit the encounter area 161. Optionally, the medical assistant 148 may store the patient token 409 outside the encounter area 161.

In block 412, the wait time system 106 records the current time as an end time for the current state (e.g., “waiting for encounter area”), changes current state (e.g., to “in encounter area”), and uses the current timestamp as a begin time for the new state. The wait time system 106 also updates the state of the encounter area 161 to “in use” and updates queue positions. The wait time system 106 may also update the walk-in display 242 or the appointment display 244, whichever is appropriate, in the waiting area 206, the CP display device 287, and/or the EA display device 220 in the encounter area 161.

In optional block 414, the wait time system 106 receives an indication that the medical assistant 148 has left the encounter area 161. The medical assistant 148 may use the EA reader 224 to read the MA token 346 upon exiting the encounter area 161. The EA reader 224 provides this information to the wait time system 106.

In block 416, the wait time system 106 receives an indication that the doctor 142 has arrived at the encounter area 161. The doctor 142 may use the EA reader 224 to read the CP token 342 upon arriving at the encounter area 161. The EA reader 224 provides this information to the wait time system 106, which acknowledges this information. Then, the doctor 142 enters the encounter area 161 and examines the patient 152.

At any time, other medical staff may enter the encounter area 161.

In optional block 418, the wait time system 106 may receive identifications of one or more actions entered (e.g., via the CP computing device 286) by the doctor 142 (e.g., a physician) and/or the medical assistant 148 (e.g., via one of the mobile devices 280 illustrated in FIG. 2 or the EA display device 220). For example, the doctor 142 and/or the medical assistant 148 may use a screen 500 displayed by the EA display device 220 to enter action(s). Referring to FIGS. 12-14, the screen 500 includes action buttons 419 that each correspond to a particular action. An action is any activity that needs to be performed for the patient 152 or the encounter area 161. Each action may be represented by an associated icon on various displays. A solid (or non-flashing) icon may be used to indicate information and a flashing icon may be used to indicate an action needs to be taken.

By way of non-limiting examples, FIG. 12 illustrates an action button 502 indicating an examination by a doctor is required and an action button 504 indicating the encounter area 161 needs cleaning. FIG. 12 also includes an indication 506 that the action button 504 has been selected. By way of other non-limiting examples, FIG. 13 illustrates an action button 512 indicating a note should be entered, an action button 514 indicating the nurse 144 is needed, an action button 516 indicating a test is needed, an action button 518 indicating the medical assistant 148 is needed, an action button 520 indicating the patient's blood pressure needs to be taken, and an action button 522 indicating medication is needed. By way of other non-limiting examples, FIG. 14 illustrates an action button 532 indicating the patient's chart needs to be completed, an action button 534 indicating the (doctor) doctor 142 is needed, an action button 536 indicating a follow up appointment is needed, an action button 538 indicating a test is needed, an action button 540 indicating a shot or vaccination is needed, and an action button 542 indicating an imaging scan is needed.

The action(s) entered may direct other medical staff (e.g., the medical assistant 148, the nurse 144, one or more of the roving workers 180 (see FIG. 1), and/or the auxiliary department 170) with respect to one or more actions that are to be taken with respect to the patient 152. Optionally, the doctor 142 and/or the medical assistant 148 may enter a priority for one or more of the action(s) or, when more than one action has been entered, change the order of the actions.

In block 420, the wait time system 106 receives an indication that the doctor 142 has left the encounter area 161. The doctor 142 may use the EA reader 224 to read the CP token 342 upon leaving the encounter area 161. The EA reader 224 provides this information to the wait time system 106, which acknowledges this information.

If one or more actions were received in block 418, in block 422, the wait time system 106 notifies (e.g., sends an action alert to) any of the medical staff 140 (see FIG. 1) who will be performing the action(s). At this point, the medical staff 140 (e.g., the roving worker 180, the employee of the auxiliary department 170, and the like) may receive a specific monitored action alert (e.g., on mobile devices 280 operated thereby). Any such medical staff moves to the encounter area 161.

In optional block 424, the wait time system 106 receives an indication that the medical staff need to perform the action(s) has arrived at the encounter area 161. This medical staff may use the EA reader 224 to read the token(s) associated with the medical staff. The EA reader 224 provides this information to the wait time system 106, which acknowledges this information. Then, the medical staff enters the encounter area 161 and completes indicated action(s) with respect to the patient 152 or the encounter area 161.

In optional block 426, the wait time system 106 may receive indications that the action(s) have been completed and closes out the action(s). The medical staff may indicate a particular action has been completed by selecting the action and pressing an appropriate one or more of the action button(s) 419 (see FIGS. 12-14) on EA display device 220. The mobile device(s) 280 used by the medical staff will indicate that the action has been completed (e.g., a notification will disappear) after the medical staff as entered such information in to the EA computing device 222.

The action(s) may indicate that the patient 152 is to be transferred to another area (e.g., a different encounter area). For example, the patient 152 may be transferred to a lab, radiology, and the like. Alternatively, the patient 152 may be ready to leave the clinic 131.

In optional block 428, the wait time system 106 receives an indication that the medical staff has left the encounter area 161. The medical staff may use the EA reader 224 to read the token(s) associated with the medical staff. The EA reader 224 provides this information to the wait time system 106, which acknowledges this information. Then, the medical staff leaves the encounter area 161. The wait time system 106 updates the status of the doctor 142 and the CP display device 287 displays information regarding a next patient visit, the status of a different encounter area status, and the location of the different encounter area.

In optional block 430, the wait time system 106 receives an indication that the patient 152 has left the encounter area 161. The medical assistant 148 may use the EA reader 224 to read the patient token 409 and the EA display device 220 to enter a change in the status (e.g., “transferred,” “end visit,” and the like) of the patient 152. The EA reader 224 and the EA display device 220 provide this information to the wait time system 106, which acknowledges this information. Then, the patient 152 exits the encounter area 161. As mentioned above, the medical assistant 148 may transfer the patient 152 to another encounter area. When this occurs, the medical assistant 148 may indicate that the encounter area 161 is to be held until the patient 152 returns.

In optional block 432, the wait time system 106 changes the status of the patient 152 and the encounter area 161. If the patient 152 is being discharged, the patient's status may be changed to indicate the patient's visit has terminated. The status of the encounter area 161 may be changed to indicate that it needs to be cleaned or available for another patient.

Then, the method 400 terminates.

During the method 400, the EA display device 220 may display a “touch time” that shows how long it has been since the last interaction with the patient 152 (see FIG. 4). The touch time may be reset every time an action is taken or one of the medical staff 140 (see FIG. 1) enters (and checks into) the encounter area 161.

Referring to FIG. 4, whenever the doctor 142, the nurse 144, or the medical assistant 148 is checked into the encounter area 161, the wait time system 106 records the current timestamp, and closes any open service events involving that party that checked in. In other words, the party is checked out of any other rooms/locations in which they may have been. Further, the EA display device 220 shows the medical staff member(s) as being inside the encounter area 161.

Whenever, the doctor 142, the nurse 144, the medical assistant 148, or the device 350 is checked into the encounter area 161, the wait time system 106 creates a service event for the patient 152 on the visit.

Computing Device

FIG. 15 is a diagram of hardware and an operating environment in conjunction with which implementations of the one or more computing devices of FIGS. 1-4 may be practiced. The description of FIG. 15 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 15 includes a general-purpose computing device in the form of the computing device 12. Each of the computing devices of FIGS. 1-4 (including the computing systems, devices, and servers 190, 216, 222, 232, 260, 270, 282, and 302-308) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 15 include a local-area network (LAN) 51 and a wide-area network (WAN) 52 (e.g., the Internet). Such networking environments are commonplace in offices, enterprise-wide computer networks, intranets, and the Internet.

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the method 400 illustrated in FIG. 5) described above. Such instructions may be stored on one or more non-transitory computer-readable media.

In some embodiments, the system memory 22 stores computer executable instructions that when executed by one or more processors cause the one or more processors to generate the screens 238, 266, and 500 illustrated in FIGS. 6, 9, and 12-14 and the admin portal 310 illustrated in FIGS. 10 and 11 described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

What is claimed is:

1. A system comprising:
a patient services computing device configured to add patients to a patient queue and assign a machine-readable token to each of the patients;
a plurality of readers each located in or near a corresponding one of a plurality of encounter areas whereat the patients are seen by one or more members of a medical staff, each of the plurality of readers being configured to read token information from the tokens assigned to the patients;
a wait time system connected to the patient services computing device and the plurality of readers, the wait time system being configured to receive the token information from a portion of the plurality of readers, identify, as being used, the encounter area corresponding to each reader in the portion, and calculate a wait time for each of a portion of the patients whose tokens have not yet been read by one of the plurality of readers;
a plurality of encounter area display devices each corresponding to one of the plurality of encounter areas, each of the plurality of encounter area display devices being configured to receive an indication from the wait time system indicating whether the corresponding encounter area is being used and, display whether the corresponding encounter area is being used based on the indication; and
a waiting area display device configured to display the wait time calculated for the portion of the patients.

2. The system of claim 1, wherein the wait time system is configure to receive a message from a first of the one or more members of a medical staff, and transmit the message to the waiting area display device for display thereby.

3. The system of claim 1, further comprising:
a plurality of encounter area computing devices each located in a corresponding one of the plurality of encounter areas, the plurality of readers being each connected to a corresponding one of the encounter area computing devices, and configured to transfer the token information thereto, the encounter area computing devices being configured to transfer the token information to the wait time system.

4. The system of claim 3, wherein the plurality of encounter area computing devices are configured to display action buttons on the plurality of encounter area display devices, receive selections of the action buttons, and transmit the selections to the wait time system, and
the wait time system is configured to record the selections received from the plurality of encounter area computing devices.

5. The system of claim 1, wherein a first patient is seen by a particular member of the medical staff in a first one of the plurality of encounter areas,
the particular member has a member token, and
after the member token is read by a first one of the plurality of readers corresponding to the first encounter area, the wait time system assigns the particular member to the first encounter area.

6. The system of claim 5, wherein a second patient is seen by the particular member in a second one of the plurality of encounter areas, and
after the member token is read by a second one of the plurality of readers corresponding to the second encounter area, the wait time system assigns the particular member to the second encounter area and releases the particular member with respect to the first encounter area.

7. The system of claim 5, wherein the first encounter area has an encounter area computing device configured to display action buttons on a first one of the plurality of encounter area display devices corresponding to the first encounter area, receive a selection of one of the action buttons, and transmit the selection to the wait time system, and
the wait time system is configured to record the selection received from the encounter area computing device.

8. The system of claim 7, wherein the particular member is a first member, and
the wait time system is configured to send an alert to a mobile computing device operated by a different second member of the medical staff based on the selection.

9. The system of claim 1, wherein the portion of the patients is a first portion,
a second portion of the patients have tokens that have not yet been read by one of the plurality of readers,
before each of the second portion of the patients leave, the token information is read a second time from the token assigned to each of the second portion of the patients by the reader corresponding to the encounter area to which the patient was assigned, and
the wait time system is configured to receive the token information read the second time, and remove the second portion of the patients from the patient queue.

9. The system of claim 1, further comprising:
an external display device connected to the wait time system and configured to display an advertised wait time calculated by the wait time system.

10. The system of claim 1, further comprising:
a kiosk connected to the wait time system, the kiosk being operable to check-in one or more of the patients and add the one or more checked-in patients to the patient queue.
